(19) United States
(12) Patent Application Publication
(10) Pub. No.: US 2008/0139650 A1
(43) Pub. Date: Jun. 12, 2008

(54) Fungicidally Active Polymer Dispersions And Use Thereof

(75) Inventors: Martin Jakob, Kelkheim (DE); Heinrich Harrer, Krefeld (DE)

Correspondence Address: CONNOLLY BOVE LODGE & HUTZ, LLP, P O BOX 2207, WILMINGTON, DE, 19899, US

(73) Assignee: CELANESE EMULSIONS GMBH, Kronberg/Ts (DE)

(21) Appl. No.: 11/576,124

(22) PCT Filed: Aug. 26, 2005
(86) PCT No.: PCT/EP05/09216

§ 371 Date: May 16, 2007

(30) Foreign Application Priority Data
Sep. 27, 2004 (DE) 10 2004 047 118.5

(51) Int. Cl. A01N 25/10; C08K 5/01; C08K 5/09; A01N 37/06; A01P 3/00; C08K 5/16; C08K 5/05

(52) U.S. Cl. 514/557; 524/81; 524/380; 524/299; 524/205; 524/197; 514/772.4

(57) ABSTRACT

A description is given of an aqueous polymer dispersion comprising
A) a polymer dispersion produced by free-radical polymerization of ethylenically unsaturated monomers,
B) stabilizers suitable for carrying out the free-radical polymerization, and also
C) 0.01 to 20 000 ppm by weight, based on the mass of the total dispersion, of at least one compound of the formula Ia and/or Ib

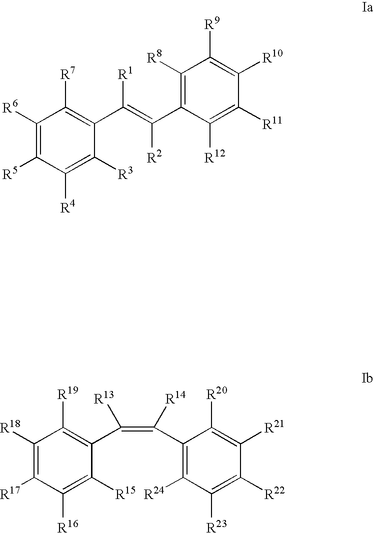

where R¹, R², R¹³ and R¹⁴ independently of one another are hydrogen, C₁-C₆-alkyl, C₁-C₆-alkoxy, carboxyl, nitrile, isonitrile, cyano or halogen,
R³ to R¹² and R¹⁵ to R²⁴ independently of one another are hydrogen and selected organic radicals, and at least one of the substituents R³ to R¹², or
R¹⁵ to R²⁴, being hydroxyl and/or alkoxy and/or alkanoyloxy.

The aqueous polymer dispersion may be used for coating foods, as color, or as adhesive, and the resultant films are distinguished by high fungicidal resistance.

The present invention relates to improved fungicidally active polymer dispersions which are suitable for coating or treating the most varied substrates and which are distinguished by high fungicidal activity and long-time action.

The use of polymer dispersions for coating foods, for example hard cheese and meat products such as sausage products, has long been known. An essential requirement of such coating agents is avoiding mold infestation on the foods during the ripening and/or storage periods.

For a relatively long time, therefore, use has been made of the polyene fungicide natamycin for coating foods by polymer dispersions.

Natamycin is a polyene macrolide having high fungicidal activity which can be isolated from the culture substrate of Streptomyces natalensis. It is a crystalline white powder without its own flavor or odor. It is soluble in diverse organic solvents, but is customarily applied as an aqueous suspension to the food coating mass, since the water solubility is relatively low at 0.005% by weight.

A property of natamycin, as also that of the various other polyene fungicides, is the chemical instability thereof. Natamycin has reactive functional groups at which the molecule can readily be reacted or fragmented by bond breakage. The secondary products generally have no microbiological activity, or only restricted microbiological activity. The breakdown proceeds not only in homogeneous solution, but also in the form of the aqueous suspension.

Substances or influences which lead to breakdown of natamycin activity have been described, for example, by H. Brik in Analytical Profiles of Drug Substances 10, 513-561 (1980). These include extremely acidic or basic pHs, high temperature, UV or gamma radiation, atmospheric oxygen, peroxides, metal ions such as Fe(III), Ni(II) or Cr(III), or the presence of sulfites or sodium formaldehyde sulfoxilate.

When natamycin is added to polymer dispersions, in addition, interactions occur between the polymeric or low-molecular-weight components present in this latex. The interactions due to adsorption of the molecule to latex surfaces and the reactions of natamycin immobilized by adsorption in the interfacial boundary area of the stabilization layer have not been investigated.

WO-A 01/45513 makes clear that even polymer dispersions based on one and the same monomer have different fungicide tolerances.

This technical problem has been countered in the past by adding stabilizing components to the polymer dispersion, which stabilizing components are said to prevent, via the addition of antioxidants, the oxidative breakdown and/or effect of metal ions by chelating agents.

WO-A-01/45513 describes a method for retaining the activity of natamycin in an aqueous solution, the solution being provided with a chelating agent and/or an antioxidant, the chelating agent and the antioxidant being able to be the same agent or different agents and also the chelating agent being able to be glycine, polyphosphate, EDTA, a salt of EDTA, 1,3-diamino-2-hydroxypropane-N,N,N′,N′-tetraacetic acid or 1,3-diaminopropane-N,N,N′,N′-tetraacetic acid and the antioxidant being able to be the same or a different agent. The antioxidant comprises ascorbic acid, citric acid, butylated hydroxyanisole, butylated hydroxytoluene, a gallate, a tocopherol, ascorbyl palmitate and/or calcium ascorbate.

Another approach is to produce the polymer dispersions using a mixed stabilization system, which is distinguished in that a protective colloid system is used which contains either no cellulose ethers or only restricted amounts of cellulose ethers, the dispersions contain low amounts of selective antioxidants and are set to a selective pH range. As a result, dispersions are obtained having a high polyene fungicide tolerance. This path is taken in the German patent application (application no. 102004042221.4) which was not published before the priority date of the present application.

These known approaches comprise multiple expenditure in the form of a downstream final processing step after production of the polymer dispersions by emulsion polymerization which increases the production costs.

Since the solubility of natamycin in the aqueous phase of the dispersion is very low and the fungicidal activity of the active compound proceeds only from the fraction of the component which is dissolved in water, under suitable environmental conditions, even in the case of the dispersion coatings finished with polyene fungicide, in the case of a peak loading, infestation by spores can occur. This relates in particular to species which respond only poorly to polyene fungicides.

Therefore, on account of the high sensitivity of polyene fungicides, there is currently a requirement for the manufacturers of polymer dispersions on the one hand, and for those offering finished food coatings compositions based on dispersions, equally for provision of alternatives to the dispersions conventionally finished with polyene fungicides or other preservatives.

In the scientific literature, stilbene derivatives having biological, in particular fungicidal, activity have already been described, for example in J. Agric. Food Chem, 2003, 51, 82-89; in The Journal of Biological Chemistry, Vol. 277 (18), 16340-4 (2002); in J. Chromatography, 32, (1968), 323-336; and in Food Chemistry 83 (2003), 585, 593.

The patent literature has likewise already disclosed biocidal applications of stilbene derivatives. For instance, WO-A-01/13,727 describes a method for protecting plants or plant parts, in which an antimicrobial composition comprising at least one lipophilic GRAS (generally-recognized-as-safe) aroma compound and at least one hydrophilic GRAS aroma compound is used. As lipophilic GRAS aroma compound, use can be made of, inter alia, polyphenol compounds. EP-A-1,418,164 discloses stilbene derivatives which can be used in pharmaceutical compositions or as food additives. US-A-2003/0118617 describes resveratrol analogs which are used in cosmetic preparations. Finally, US-A-2002/0028852 describes resveratrol analogs which are used for prophylaxis of diseases. None of these publications describes the use of stilbene derivatives in polymer dispersions.

WO-A-00/21,368 describes hydroxystilbene compounds as active microbicidal compounds. These are used for the antimicrobial treatment of surfaces, for example as bodycare compositions, but also for the antimicrobial finishing or preservation of plastics, papers or nonwovens. The use of these hydroxystilbene compounds in plastic dispersions which have been produced by free-radical emulsion polymerization is not disclosed.

DE-A-199 55 153 describes water-repellant finished plastic resin dispersions adhering well to alkaline building materials and which are finished with a fungicide. As fungicides, 4-hydroxybenzoic esters are proposed.

The biocidal activities of stilbene derivatives observed in the formulations described to date cannot be applied to polymer dispersions simply, since, as has been described above, numerous interactions among the components specific for the polymer dispersion must be expected and predicting the properties of the total system is not reliably possible.

The same applies to results which have been obtained in systems using other fungicides.

It has now surprisingly been found that selected stilbene derivatives used in polymer dispersions exhibit outstanding fungicidal activities.

The object therefore underlying the present invention is to provide fungicidally finished polymer dispersions whose activity is comparable to that of polymer dispersions finished with polyene fungicides and which have a higher stability than conventionally finished polymer dispersions.

A further object of the present invention relates to providing fungicidally finished polymer films or polymer layers which are derived from fungicidally finished polymer dispersions, the fungicide having a high chemical stability and being able to develop its activity or a coating film or polymer layer produced from the polymer dispersion.

Surprisingly it has now been found that these objects are achieved by polymer dispersions which comprise at least one fungicide based on a hydroxy-substituted and/or alkoxy-substituted and/or acyloyloxy-substituted stilbene derivative, in particular E-3,4′,5-trihydroxystilbene (trans-resveratrol).

The present invention thus relates to an aqueous polymer dispersion comprising
A) a polymer dispersion produced by free-radical polymerization of ethylenically unsaturated monomers,
B) stabilizers suitable for carrying out the free-radical polymerization, and also
C) 0.01 to 20 000 ppm by weight, based on the mass of the total dispersion, of at least one compound of the formula Ia and/or Ib

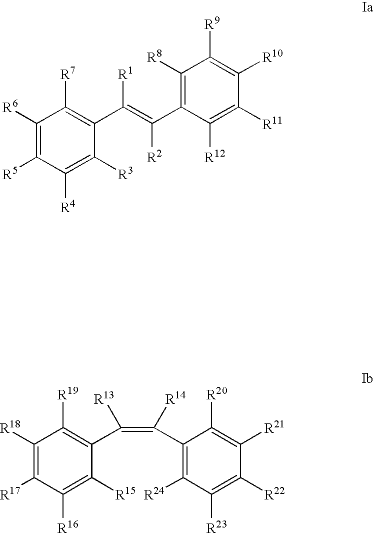

where R¹, R², R¹³ and R¹⁴ independently of one another are hydrogen, C₁-C₆-alkyl, C₁-C₆-alkoxy, carboxyl, nitrile, isonitrile, cyano or halogen,
R³, R⁴, R⁵, R⁶, R⁷, R⁸, R⁹, R¹⁰, R¹¹, R¹², R¹⁵, R¹⁶, R¹⁷, R¹⁸, R¹⁹, R²⁰, R²¹, R²², R²³ and R²⁴ independently of one another of hydrogen, C₁-C₁₂-alkyl, C₂-C₁₂-alkenyl, C₁-C₁₂-alkoxy, hydroxyl, carboxyl, —CO—R²⁵, —O—CO—R²⁶, the oxygen-bound monovalent radical are a carbohydrate or halogen, and
R²⁵ and R²⁶ independently of one another are C₁-C₁₂-alkyl or C₂-C₁₂-alkenyl, with the proviso that at least one of the substituents R³, R⁴, R⁵, R⁶, R⁷, R⁸, R⁹, R¹⁰, R¹¹ or R¹², or R¹⁵, R¹⁶, R¹⁷, R¹⁸, R¹⁹, R²⁰, R²¹, R²², R²³ or R²⁴, preferably R¹⁵, R¹⁶, R¹⁷, R¹⁸, R¹⁹, R²⁰, R²¹, or R²², is hydroxyl and/or alkoxy and/or —O—CO—R²⁶.

The aqueous polymer dispersions of the invention can be derived from any desired ethylenically unsaturated monomers which can be polymerized by free-radical mechanisms or combinations thereof.

Preferably, the polymer dispersions of the invention are derived from monomers of one or more of the following groups:
a) esters of acrylic acid and/or methacrylic acid with monohydric aliphatic saturated alcohols having one to eighteen carbon atoms including the monohydric aliphatic saturated alcohols which are derived from alkylene glycols, for example from methyl acrylate, butyl acrylate, 2-ethylhexyl acrylate and/or the corresponding methacrylates;
b) esters of acrylic acid and/or methacrylic acid with dihydric aliphatic saturated alcohols having two to eighteen carbon atoms, for example with ethylene, propylene or butylene glycol;
c) ester amides of acrylic acid and/or methacrylic acid with aliphatic saturated amino alcohols having two to eighteen carbon atoms, for example with diethylamine alcohol;
d) vinyl esters or allyl esters of aliphatic saturated or unsaturated monocarboxylic acids having one to eighteen carbon atoms in the carboxylic acid moiety, for example vinyl acetate, vinyl acrylate, vinyl methacrylate, vinyl crotonate, allyl acetate, allyl acrylate, allyl crotonate and/or allyl methacrylate;
e) divinyl esters or diallyl esters of aliphatic saturated or unsaturated dicarboxylic acids having three to eighteen carbon atoms in the carboxylic acid moiety, for example divinyl maleate;
f) vinyl halides, in particular vinyl chloride and/or vinylidene chloride;
g) nitriles of ethylenically unsaturated monomers, in particular acrylonitrile and/or methacrylonitrile;
h) monounsaturated or polyunsaturated aliphatic or aliphatic-aromatic hydrocarbons which if appropriate have one or more halogen atoms, for example ethylene, butadiene, isoprene, isobutylene, propylene, 2-chlorobutadiene, 2,3-dichlorobutadiene, tetrafluoroethylene and styrene;
i) esters of maleic and/or fumaric acid with monohydric saturated aliphatic alcohols having one to eighteen carbon atoms;
j) vinyl ethers of monohydric saturated aliphatic alcohols having one to eighteen carbon atoms;
k) ethylenically unsaturated carboxylic and/or sulfonic acids, in particular acrylic acid, methacrylic acid, crotonic acid, maleic acid, fumaric acid, itaconic acid, vinylsulfonic acid and/or styrenesulfonic acid;
l) half esters of the acids mentioned under k) and having at least two acid groups with monohydric saturated aliphatic alcohols having one to eighteen carbon atoms, in particular potassium and ammonium salts thereof;
m) vinyl heterocycles or allyl heterocycles, such as vinylpyrrolidone or triallyl cyanurate; and/or
n) amides of the acids mentioned under k), including the N-methylolamides and ethers thereof.

Polymer dispersions which are preferably used are derived from vinyl esters of aliphatic saturated or unsaturated monocarboxylic acids having one to eighteen carbon atoms in the carboxylic acid moiety, in particular from vinyl acetate, vinyl propionate, vinyl butyrate, vinyl isobutyrate, vinyl pivalate, vinyl 2-ethylhexanoate, vinyl esters of α-branched carboxylic acids having 9 to 11 carbon atoms in the acid radical (®Versatic acids), and also from vinyl esters of lauric, palmitic, myristic and stearic acids.

Polymer dispersions which are particularly preferably used are derived from combinations of one or more vinyl esters with ethylene.

A further particularly preferred group of polymer dispersions used according to the invention is derived from esters of acrylic acid and/or esters of methacrylic acid with monohydric aliphatic saturated alcohols having one to eight carbon atoms which if appropriate are used together with alpha-olefins, such as ethylene, and/or vinyl esters, such as vinyl acetate.

A further particularly preferred group of polymer dispersions used according to the invention is derived from esters of maleic and/or fumaric acid with monohydric saturated aliphatic alcohols having four to eight carbon atoms, in particular from dibutyl maleinate and/or dibutyl fumarate which are used, if appropriate, in combination with alpha-olefins, such as ethylene, and/or vinyl esters, such as vinyl acetate.

A further ethylenically unsaturated monomer preferably used is sodium 2-sulfone ethyl methacrylate.

Particularly preferably, use is made of polymer dispersions which are derived from one or more of the following monomers:
vinyl acetate,
ethylene,
vinyl esters of saturated fatty acids of chain length C₂-C₁₈,
maleic and/or fumaric esters with monohydric saturated aliphatic alcohols of chain length C₄-C₈, and/or
acrylic and/or methacrylic esters with monohydric saturated aliphatic alcohols of chain length C₁-C₈ in combination with alpha-olefins of chain length C₂-C₁₈.

Very particularly preferably, use is made of polymer dispersions which are derived from one or more of the following monomers:
vinyl esters of saturated fatty acids of chain length C₂-C₁₈, and/or
maleic and/or fumaric esters with monohydric saturated aliphatic alcohols of chain length C₄-C₈ and/or
ethylene.

If some radicals are “alkyl radicals”, these are to be taken to mean, in the context of this description, straight-chain or branched saturated aliphatic hydrocarbon radicals. Alkyl groups, in the context of this description, are saturated aliphatic hydrocarbon radicals having one to twelve carbon atoms, preferably having one to six carbon atoms.

Examples of alkyl radicals are methyl, ethyl, propyl, isopropyl, 2-methyl-propyl, 1-butyl, 2-butyl, isobutyl, tert-butyl, 2-methylbutyl, 1,1-dimethyl-propyl, n-pentyl, n-hexyl, n-heptyl, 2-ethylhexyl or octyl.

If some radicals are “alkoxy radicals”, these are to be taken to mean, in the context of this description, straight-chain or branched saturated aliphatic hydrocarbon radicals, which are bonded to another group via an oxygen atom. Alkoxy groups, in the context of this description, are oxygen-linked saturated aliphatic hydrocarbon radicals having one to twelve carbon atoms, preferably one to six carbon atoms.

Examples of alkoxy groups are methoxy, ethoxy, propyloxy, isopropyloxy, 1-butyloxy, 2-butyloxy, isobutyloxy, tert-butyloxy, 2-methylbutyloxy, 1,1-dimethylpropyloxy, n-pentyloxy and n-hexyloxy.

If some radicals are “alkenyl radicals”, these are to be taken to mean, in the context of this description, straight-chain or branched unsaturated aliphatic hydrocarbon radicals which have one or more unconjugated double bonds. Alkenyl groups, in the context of this description, are unsaturated aliphatic hydrocarbon radicals having two to twelve carbon atoms, preferably having two to six carbon atoms.

Examples of alkenyl groups are vinyl, allyl, 2-methyl-2-propenyl, 1- or 2-butenyl, pentenyl, 2-methylpentenyl, hexenyl, heptenyl or octenyl, preferably vinyl and allyl, in particular vinyl.

If some radicals are “monovalent radicals of a carbohydrate”, in the context of this description, these are to be taken to mean oxygen-bound radicals of any desired oligosaccharides, for example di- or trisaccharides, or in particular monosaccharides. Preferred radicals are monovalent radicals derived from D-ribose, D-xylose, L-arabinose, D-glucose, D-mannose, D-galactose, D-fructose and D-sorbose. Particular preference is given to the monohydric radical derived from D-glucose.

Halogen atoms in the context of this description are fluorine, chlorine, bromine and iodine. Preference is given to chlorine.

As fungicide, preferably use is made of a compound of the formula Ia or a combination of the compounds of the formulae Ia and Ib.

The fraction of compounds of the formulae Ia and/or Ib in the polymer dispersion is 0.01 to 20 000 ppm by weight, preferably 0.1 to 5000 ppm by weight.

Preferably, use is made of compounds of the formulae Ia and/or Ib, where at least two, particularly preferably at least three, of the substituents R³, R⁴, R⁵, R⁶, R⁷, R⁸, R⁹, R¹⁰, R¹¹ or R¹², or R¹⁵, R¹⁶, R¹⁷, R¹⁸, R¹⁹, R²⁰, R²¹, R²², R²³ or R²⁴ are hydroxyl and/or alkoxy.

Preferably, use is made of compounds of the formulae Ia and/or Ib, where R¹ and R², or R¹³ and R¹⁴, are hydrogen.

Likewise preferably, use is made of compounds of the formulae Ia and/or Ib, where at least two, in particular at least three, of the substituents R³, R⁴, R⁵, R⁶, R⁷, R⁸, R⁹, R¹⁰, R¹¹ or R¹², or R¹⁵, R¹⁶, R¹⁷, R¹⁸, R¹⁹, R²⁰, R²¹, R²², R²³ or R²⁴ are hydroxyl and/or alkoxy, and where at least one of the substituents R³, R⁴, R⁵, R⁶, R⁷, R⁸, R⁹, R¹⁰, R¹¹ or R¹², or R¹⁵, R¹⁶, R¹⁷, R¹⁸, R¹⁹, R²⁰, R²¹, R²², R²³ or R²⁴ are alkyl and/or alkenyl and/or acyloyl and/or an oxygen-bound radical of a carbohydrate, in particular 2,6-dimethylocta-2,5-dienyl, acetyl and/or O-β-D-glucose.

Particularly preferably, use is made of compounds of the formulae Ia and/or Ib, where at least two, in particular at least three, of the substituents R³, R⁴, R⁵, R⁶, R⁷, R⁸, R⁹, R¹⁰, R¹¹ or R¹², or R¹⁵, R¹⁶, R¹⁷, R¹⁸, R¹⁹, R²⁰, R²¹, R²², R²³ or R²⁴ are hydroxyl, and where at least one of the substituents R³, R⁴, R⁵, R⁶, R⁷, R⁸, R⁹, R¹⁰, R¹¹ or R¹² or R¹⁵, R¹⁶, R¹⁷, R¹⁸, R¹⁹, R²⁰, R²¹, R²², R²³ or R²⁴ are alkoxy, and/or acyloyl and/or an oxygen-bound radical of a carbohydrate, in particular methoxy, acetyl and/or O-β-D-glucose.

Particularly preferably used compounds of the formulae Ia and/or Ib are 4-hydroxystilbene, 3,5-dihydroxystilbene (pinosylvin), 4,4′-dihydroxy-stilbene, 3,5,4′-trihydroxystilbene (resveratrol), 3,5,3′,4′-tetrahydroxy-stilbene, 3,5,2′,4′-tetrahydroxystilbene (oxyresveratrol), 3,5,2′,4′-tetra-hydroxy-4-(2,6-dimethylocta-2,5-dienyl)stilbene (chlorophorin), 3-hydroxy-5-methoxystilbene (pinosylvin monomethyl ether), 3′-methoxy-4′-hydroxy-stilbene, 3,5,3′-trihydroxy-4′-methoxystilbene (rhapontigenin), 4′-hydroxy-4,3′-dimethoxystilbene, 4′-hydroxy-3,5-dimethoxystilbene (pterostilbene), 3,3′-dimethoxy-4,4′-dihydroxystilbene, 5,4′-dihydroxy-3-(O-D-glucosidyl)-stilbene (resveratrol glucoside), 5,4′,5′-trihydroxy-3-(O-D glucosidyl)stilbene (astringin), 5,3′-dihydroxy-4′-methoxy-3-(O-D-glucosidyl)stilbene (rapotin), 3,5-dihydroxy-4′-methoxystilbene, 3,4′-dihydroxy-5-hydroxystilbene, 3,4′-dihydroxy-5-(O-D-glucosidyl)stilbene (piccid), 3,5,3′-trihydroxy-4′-methoxystilbene (rhapontigenin), 3,5-dihydroxy-4′-methoxy-3′-(O-D-glucosidyl)stilbene (rhaponticin), 3,5,4′-trimethoxystilbene (trimethylresveratrol), 3,5-dimethoxy-4′-acetyl-stilbene (pterostilbene acetate), 3,4,2′,4′,6′-pentamethoxystilbene, 5-methoxy-3-(O-D-glucosidyl)stilbene (pinosylvin monomethyl ether glucoside), 3′-methoxy-4′-hydroxystilbene glucoside, 3′-methoxy-4′-(O-hydroxyglucoside acetate)stilbene, 4′-methoxy-5,3′-diacetyl-3-(O-D-glucosidyl acetate)stilbene (rhapotin acetate), 4,3′-dimethoxy-4′-hydroxystilbene glucoside, 4,3′-dimethoxy-4′-hydroxystilbene glucoside acetate, 3,5,2′,4′-tetraacetylstilbene (oxyresveratrol acetate) and 5,3′,4′-triacetyl-3-(O-D-glucosidyl)stilbene (astringin acetate).

Very particular preference is given to use of E-3,5,4′-trihydroxystilbene.

The dispersions of the invention, in addition to compounds of the formulae Ia and/or Ib, can contain further biocidally active compounds, in particular further fungicides and/or additional bactericides.

Examples of additional fungicides are polyene fungicides and, in particular, natamycin, combinations of polyene fungicides, and imidazole fungicides or imazalil sulfate.

Combinations of polyene fungicides and imidazole fungicides are disclosed by EP-A-748,588. EP-A-986,965 describes the use of imazalil sulfate in vinyl acetate dispersions.

Examples of preferred further biocidally active compounds are sorbic acid, esters thereof and/or salts thereof, in particular the alkali metal salts or alkaline earth metal salts of sorbic acid.

Particular preference is given to aqueous polymer dispersions containing at least one compound of the formula Ia and at least one alkali metal salt or alkaline earth metal salt of sorbic acid.

Particularly preferably, use is made of aqueous copolymer polyvinyl ester dispersions comprising at least one compound of the formula Ia.

Likewise particularly preferably, use is made of aqueous polyacrylate and/or polymethacrylate dispersions comprising at least one compound of the formula Ia.

The polymer dispersions of the invention comprise, as component B), stabilizers suitable for carrying out the free-radical polymerization. These can be emulsifiers and/or protective colloids which, if appropriate, can also form part of the polymer (polymerized units having emulsifying groups). Preferred components B) are emulsifiers and/or protective colloids.

Protective colloids are polymeric stabilizers. Examples of these are methylcelluloses, hydroxyethyl- and propylcelluloses and also sodium carboxymethylcellulose, gelatin, casein, starch, gum arabic, hydroxyethylstarch, sodium alginate, and further homopolymers or copolymers such as, for example, vinyl esters, (meth)acrylic acids and/or esters and also N-vinylamides, including N-vinyllactams and/or the water-soluble salts of these homopolymers or copolymers. Examples of (meth)acrylic acids are polyacrylic acid and/or polymethacrylic acid. Examples of N-vinylamides are polyvinylpyrrolidone and N-vinylacetamide.

The preferred protective colloid is polyvinyl alcohol. A suitable polyvinyl alcohol has degrees of hydrolysis of 60 to 100 mol % and viscosities of the 4% strength aqueous solutions at 20° C. of 2-70 mPa·s, in particular 30 to 70 mPa·s (determined in accordance with Höppner).

Preferably, use is made of at least one relatively high molecular weight poly(vinyl alcohol) of a degree of hydrolysis of 85-92 mol % having a viscosity of the 4% strength aqueous solutions at 20° C. of 30 to 70 mPa·s (determined in accordance with Höppner).

Further suitable polyvinyl alcohols can have been hydrophobically or hydrophilically modified in any desired manner.

Examples of hydrophobically modified polyvinyl alcohols which do not contain water-soluble monomer units in their main chain are ethylene-containing polyvinyl alcohols of the Exceval® type from Kuraray.

Another possibility is modification by grafting reactions at the alcohol groups, such as, for example, the partial acetalization of the alcohol groups of polyvinyl alcohol, in which case the polyvinyl alcohols can be furnished with any desired radicals which can be either hydrophobic or hydrophilic, such as, for example, polyvinyl alcohols of the Mowiflex® type from Kuraray.

Said protective colloids can of course also be used in the form of mixtures.

Particularly preferably, use is made of polyvinyl alcohol as protective colloid, predominantly use being made of the above-described relatively high molecular weight polyvinyl alcohol which if appropriate also has small amounts, for example up to 10% by weight, based on the total amount of the protective colloid used, of other protective colloids.

The relatively high molecular weight polyvinyl alcohol preferably used is preferably present at least 60% by weight, based on the total amount of protective colloid used, very particularly preferably at 75 to 100% by weight in the protective colloid.

The amount of protective colloids used, based on the polymer, is typically 0.01 to 30 parts by weight, preferably 0.1 to 20 parts by weight.

In addition to or instead of protective colloids, the polymer dispersion of the invention can also be stabilized by using emulsifiers. Use can be made of cationic, anionic and nonionic emulsifiers or mixtures thereof.

Suitable nonionic emulsifiers are, in particular, acyl, alkyl, oleyl and alkylaryl oxethylates. These products are obtainable, for example, commercially under the name Genapol® or Lutensol®. These include, for example, ethoxylated mono-, di- and trialkylphenols (EO degree: 3 to 50, alkyl substituent radical: C₄ to C₁₂) and also ethoxylated fatty alcohols (EO degree: 3 to 80; alkyl radical: C₈ to C₃₆), especially C₁₂-C₁₄₋fatty alcohol (3-8) ethoxylates, C₁₃CO₁₅-oxo-alcohol (3-30) ethoxylates, C₁₆C₁₈-fatty alcohol (11-80) ethoxylates, C₁₀-oxo-alcohol (3-11) ethoxylates, C₁₃-oxo-alcohol (3-20) ethoxylates, polyoxyethylene sorbitan monooleate having 20 ethylene oxide groups, copolymers of ethylene oxide and propylene oxide having a minimum content of 10% by weight ethylene oxide, the polyethylene oxide (4-20) ethers of oleyl alcohol and also the polyethene oxide (4-20) ethers of nonylphenol. Particularly suitable compounds are the polyethylene oxide (4-20) ethers of fatty alcohols, in particular of oleyl alcohol. 0.1 to 10 parts by weight, preferably 0.5 to 5.0% of nonionic emulsifiers, based on the copolymer A), are used.

Suitable anionic emulsifiers are, for example, alkali metal salts and ammonium salts of alkyl sulfates (alkyl radical: C₈ to C₁₂), such as sodium lauryl sulfate, of sulfuric half esters of ethoxylated alkanols (EO degree: 4 to 30, alkyl radical: C₁₂ to C₁₈), such as ethoxylated sodium lauryl ether sulfate (EO degree 3), and ethoxylated alkylphenols (EO degree: 3 to 50, alkyl radical: C₄ to C₁₂), of alkylsulfonic acids (alkyl radical: C₁₂ to C₁₈) and of alkylarylsulfonic acids (alkyl radical: C₉ to C₁₈), and also sodium, potassium and ammonium salts of straight-chain aliphatic carboxylic acids of chain length C₁₂-C₂₀, or alkali metal salts of sulfosuccinic esters with aliphatic saturated monohydric alcohols of chain length C₄-C₁₆, sulfosuccinic 4-esters with polyethylene glycol ethers of monohydric aliphatic alcohols of chain length C₁₀-C₁₂ (disodium salt), sulfosuccinic 4-esters with polyethylene glycol nonylphenyl ether (disodium salt) and sulfosuccinic acid biscyclohexyl ester (sodium salt).

Further anionic emulsifiers have proven to have been, in addition, compounds of the formula II

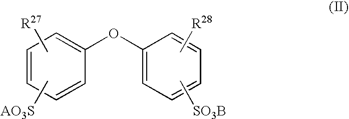

where R²⁷ and R²⁸ are H atom or C₄ to C₂₄-alkyl and are not simultaneously hydrogen atoms, and A and B can be alkali metal ions and/or ammonium ions. In the formula II, R²⁷ and R²⁸ are preferably linear or branched alkyl radicals having 6 to 18 carbon atoms, in particular having 6, 12 and 16 carbon atoms or hydrogen, R²⁷ and R²⁶ not both being simultaneously hydrogen atoms. A and B are preferably sodium, potassium or ammonium, sodium being particularly preferred. Particularly advantageous are compounds II where A and B are sodium, R²⁷ a branched alkyl radical having 12 carbon atoms and R²⁸ is a hydrogen atom or R²⁷. Frequently, technical mixtures are used which have a fraction of 50 to 90% by weight of the monoalkylated product, such as, for example, Dowfax® 2A1 (trade name of the Dow Chemical Company). The compounds II are generally known, for example, from U.S. Pat. No. 4,269,749, and are commercially available.

Suitable cationic emulsifiers are, for example, C₆ to C₁₈-alkyl- or -aralkyl- or heterocyclic radical-bearing primary, secondary, tertiary or quaternary ammonium salts, alkanolammonium salts, pyridinium salts, imidazolinium salts, oxazolinium salts, morpholinium salts, thiazolinium salts and also salts of amine oxides, quinolinium salts, isoquinolinium salts, tropylium salts, sulfonium salts and phosphonium salts.

Those which may be mentioned by way of example are dodecylammonium acetate or the corresponding hydrochloride, the chlorides or acetates of the various 2-(N,N,N-triethylammonium)ethylparaffinic esters, N-cetylpyridinium chloride, N-laurylpyridinium sulfate and also N-cetyl-N,N,N-trimethylammonium bromide, N-dodecyl-N,N,N-trimethylammonium bromide, N-octyl-N,N,N-trimethylammonium bromide, N,N-distearyl-N,N-dimethylammonium chloride and also the gemini surfactant N,N′-(lauryldimethyl)ethylenediamine dibromide. Numerous other examples may be found in H. Stache, Tensid-Taschenbuch [Surfactant Handbook], Carl-Hanser-Verlag, Munich, Vienna, 1981 and in McCutcheon's, Emulsifiers & Detergents, MC Publishing Company, Glen Rock, 1989.

The solids content of the aqueous polymer dispersions of the invention is typically 20 to 70% by weight, preferably 30 to 65% by weight, and particularly preferably 40 to 60% by weight.

The aqueous polymer dispersions of the invention, in addition to an excellent storage stability, are distinguished by a very favorable biological stability.

The present invention also relates to films which are obtainable by film-forming the aqueous plastic dispersions of the invention.

These can be coatings which are obtainable by applying the aqueous plastic dispersions of the invention to a substrate.

Any desired substrates can be used which are to be finished with a fungicide. Examples of substrates are foods, such as sausage, fruits or in particular cheese, and also wood, plastics or paper.

However, they can also be self-supporting films which are obtainable by film-forming the aqueous plastic dispersions of the invention, for example by application to a temporary support, developing a film by evaporating the water and subsequent detachment of the film formed from the temporary support.

A further embodiment of the inventive films is plastic layers which are obtainable by film-forming the plastic dispersions of the invention and which are situated between at least two substrates and stick them together.

The inventive aqueous polymer dispersions can be prepared by free-radical emulsion polymerization which is known per se, or variants thereof, such as, for example, miniemulsion polymerization, or by redispersion of dispersion powders containing polymer particles prepared by free-radical emulsion polymerization and compounds of the formulae Ia and/or Ib.

The polymerization can be carried out in the batch method, in the fed-batch method, or combined batch/fed-batch method or in continuous loop reactors or stirred-tank cascades.

Preferably, an emulsion polymerization is carried out in the combined batch/fed-batch method, or particularly preferably, in the fed-batch method, customarily a part of the monomers (1 to 15% by weight) being charged to start the polymerization. The monomers can be added either together or in separate feeds. In addition, it can be advantageous, in certain embodiments, to carry out a seed polymerization to set specific particle sizes and particle size distributions.

As free-radical initiators, use is made of the free-radical starters which are known per se.

Examples of these are: hydrogen peroxide, benzoyl peroxide, cyclohexanone peroxide, isopropylcumyl hydroperoxide, persulfates of potassium, sodium and ammonium, peroxides of even-numbered saturated monobasic aliphatic carboxylic acids of chain length C₈-C₁₂, tertiary butyl hydroperoxide, ditertiary butyl peroxide, diisopropyl percarbonate, azoisobutyrodinitrile, acetylcyclohexanesulfonyl peroxide, tertiary butyl perbenzoate, tertiary butyl peroctoate, bis(3,5,5-trimethyl)hexanoyl peroxide, tertiary butyl perpivalate, hydroperoxypinane, p-methane hydroperoxide. The abovementioned compounds can also be used within a redox system, in which case transition metal salts such as iron(II) salts or other reducing agents are used conjointly. As reducing agents, or regulators, use can be made conjointly of alkali metal salts of oxymethanesulfinic acid, mercaptans of chain length C₁₀-C₁₄, but-(1)-en-(3)-ol, hydroxylamine salts, sodium dialkyldithiocarbamate, sodium bisulfite, ammonium bisulfite, sodium dithionite, diisopropyl xanthogen disulfide, ascorbic acid, tartaric acid, isoascorbic acid, boric acid, urea and formic acid.

Preferably, however, use is made of water-soluble persulfates, in particular ammonium persulfate or sodium persulfate, for initiating polymerization.

The protective colloid or protective colloids used for stabilization can likewise either be charged in advance completely at the start of polymerization or charged in advance in part and metered in part, or added completely during the polymerization.

The emulsifier used for stabilization can likewise either be charged in advance completely at the start of polymerization or charged in advance in part and metered in part, or added completely during polymerization. In a preferred embodiment, this component is charged in advance in part and metered in part. The same applies in principle to the conjoint use of one or more further ionic coemulsifiers.

The polymerization temperature typically ranges from 20 to 120° C., preferably from 30 to 110° C., and very particularly preferably from 45 to 95° C.

After completion of polymerization, for demonomerization a furthers preferably chemical, post-treatment, in particular with redox catalysts, can follow, like, for example, combinations of the abovementioned oxidizing agents and reducing agents. In addition, residue monomer present can be removed in a known manner, for example by physical demonomerization, that is removal by distillation (in particular by steam distillation) or by stripping using an inert gas. A combination of physical and chemical methods is particularly efficient which permits reduction of the residue monomers to very low contents (<1000 ppm, preferably <100 ppm).

The fungicide of the formulae Ia and/or Ib is added to the polymer dispersion after preparation thereof. In addition, further additives specific to the application can be added.

Suitable further additives or stabilizers for preparation of the polymer dispersion of the invention, in particular for use in the food sector, are methylcelluloses, hydroxyethyl- and propylcelluloses and also sodium carboxymethylcellulose. These can be used conjointly in principle for adaptation of specific properties such as glossiness and water vapor transmission rate and also for stability improvement. This group of compounds encompasses gelatin, casein, starch, gum arabic, hydroxyethyl starch, sodium alginate, lactose, silicon dioxide and also further homopolymers or copolymers, for example polyacrylic acid and polyvinylpyrrolidone.

After preparation of the polymer dispersion of the invention, further aids can be added to it. This group encompasses, for example, said stabilizers. Suitable additives are, of course, also low molecular weight stabilizers such as neutralizing agents and complexing agents. Those which may be mentioned by way of example are alkali metal, ammonium and calcium hydroxides, carbonates, phosphates, alkali metal salts of ethylenediamine-tetraacetic acid and N-hydroxyethylenediaminetriacetic acid, citric acid, and also sodium acetate and phosphoric acid, ammonium chloride, sodium sulfate, homopolymer of 2-acrylamido-2-methylpropanesulfonic acid and its sodium, potassium and ammonium salts, and also, in addition to the compounds of the formulae Ia and/or Ib, in addition biocides, that is substances for protection of the dispersion and/or the packaged substrate against microbial attack. Preferably, use is made of preservatives which are permitted in the relevant regulations under food law for additives for cheese and the other foods to be coated.

If the dispersion is finally processed to give a mass for coating foods, use can be made of the colors permitted in the relevant positive lists such as carotene (E 160a), annatto (E 160b), carbo medicinalis vegetabilis (E 153), titanium dioxide (E 171), tartrazine (E 102), quinoline yellow (E 104), sunset yellow FCF (E 110), cochineal red A (E 124), indigotine (E 132), brilliant black BN (E 151) or lithoirubine BK (E 180).

The aqueous polymer dispersions of the invention may be used, in particular, for coating and/or packaging of foods, as colors or as adhesives.

The aqueous polymer dispersions of the invention may also be used for preparation of water-redispersible polymer powders. For preparation thereof, the aqueous dispersions, if appropriate after addition of protective colloids as atomization aid, are dried, for example by fluidized bed drying, freeze drying or spray drying. Preferably, the dispersions are spray dried. Spray drying proceeds in conventional spray-drying plants, in which case the atomization can proceed by means of single-, two- or multiple-fluid nozzles or using a rotating disk. The exit temperature is generally selected in the range from 45° C. to 120° C., preferably 60° C. to 90° C., depending on plant, T_{g} of the resin and desired degree of drying. Generally, the atomization aid is used in a total amount of 3 to 30% by weight, based on the polymeric components of the dispersion. That is the total amount of protective colloid before the drying operation is to be at least 3 to 30% by weight, based on the polymer fraction; preferably use is made of 5 to 20% by weight, based on the polymer fraction. Further suitable atomization aids are modified polyvinyl alcohols.

Very particularly preferably, the aqueous polymer dispersions of the invention are suitable aids for cheese ripening and also as coating agents and/or as packaging material for foods of all types.

These uses are likewise subject matter of the present invention.

The examples hereinafter illustrate the invention without restricting it.

### EXAMPLES 1-7 AND COMPARATIVE EXAMPLES C₁-C₃

Commercially conventional dispersions based on poly(vinyl alcohol)-stabilized poly(dibutyl maleinate-co-vinyl acetate) were, where necessary, set to the required pH using 10% strength sodium hydroxide solution and subsequently finished with fungicide. In addition, to the dispersion was added either a 1% strength ethanolic solution of the fungicide or an aqueous suspension which had been prepared by weighing out exactly 500 mg of fungicide into a 50 ml measuring flask and subsequently making up to 50 ml with deionized water to the calibration mark. After addition, the substance was distributed well in the dispersion and approximately 200 μm thick films were produced using a drawing frame with wet application of 400 μm.

### Fungicides Used:

F1: trans-3,5,4′-trihydroxystilbene (trans-resveratrol). Commercially conventional product from Sigma was used (active content 99%).
F2: natamycin. Use was made of Delvocid®, commercially conventional natamycin (50% active content) from DSM Food Specialities. The concentrations stated relate to pure natamycin.

### Dispersions Used:

Dispersion A: Mowilith® SDM 4230 KL approximately 45% strength, commercial product of Celanese Emulsions GmbH. The pH was 4.5.
Dispersion B; Mowilith® SSK-1 KL approximately 48% strength, commercial product of Celanese Emulsions GmbH. For the load tests, the pH was set from 3 to 4.5.

The action of these films on microorganisms was determined using the method ISO 846.

### Method A: Fungal Growth Test

The samples were applied to an incomplete nutrient medium (without carbon source) and inoculated with a spore suspension of various fungi. The fungi were only able to grow using the sample material (as carbon source). If the samples did not contain utilizable nutrients, the fungi could not develop mycelia and the plastic was not destroyed. Method A is suitable for assessing the resistance of the sample to fungal infestation when no other utilizable organic materials are present.

### Method B: Determination of the Fungistatic Activity

The samples were applied to a complete nutrient medium (with carbon source) and inoculated with a spore suspension of various fungi. Even if the plastic did not contain utilizable nutrients, the fungi could overgrow the sample and their metabolic products were able to attack the material. Any inhibition of fungal growth not only on the plastic but also on the nutrient medium (inhibition zone) exhibited a fungistatic activity of the plastic or the presence of an antifungal finish. Method B is intended to reflect the situation of a surface contamination of the sample in practice (such as dirt or organic deposits).

The inoculum in all the determinations was performed using spores of Aspergillus niger and Aspergillus versicolor.

The samples, after expiry of the incubation period of 28 days, were assessed in methods A and B using the following rating key in accordance with ISO 846 (a, b=individual results of duplicate determination).

0=no growth recognizable on microscopic examination,

1=light growth, no growth visible by naked eye, easily recognizable microscopically,

2=light growth, easily seen macroscopically, at most 25% of the sample surface ovegrown,

3=moderate growth, up to 50% of sample surface overgrown,

4=heavy growth, over 50% of sample surface, but not the entire surface overgrown,

5=heavy growth on the entire sample surface.

TABLE 1
Results of the loading tests as specified in ISO 846

| | | | Method A | | Method B | |
|---|---|---|---|---|---|---|
| Example | Dispersion | Addition | a | b | a | b |
| Reference | A | None | 2 | 1 | 3 | 3 |
| (untreated) | | | | | | |
| 1 | A | 10 ppm F1 | 2 | 0 | 2 | 0 |
| | | (ethanolic) | | | | |
| 2 | A | 100 ppm F1 | 0 | 0 | 3 | 3 |
| | | (ethanolic) | | | | |
| 3 | A | 10 ppm F1 | 0 | 1 | 3 | 3 |
| | | (suspension) | | | | |
| 4 | B | 10 ppm F1 | 1 | 1 | 1 | 1 |
| | | (ethanolic) | | | | |
| 5 | B | 50 ppm F1 | 1 | 1 | 2 | 1 |
| | | (ethanolic) | | | | |
| C1 | B | 10 ppm F2 | 0 | 1 | 2 | 2 |
| | | (ethanolic) | | | | |

These results make clear that trans-resveratrol in polymer dispersions made into films exhibits fungicidal activity and the mode of action of trans-resveratrol corresponds to that of natamycin.

Determination of Fungicide Recovery Rates after Storage Using HPLC

For this, dispersions at defined pHs, which if appropriate were set using 10% strength NaOH, were admixed with defined amounts of fungicide (natamycin from suspension, trans-resveratrol from methanolic solution) and after thorough mixing their exact concentration was determined by HPLC. After storage for 7 days at 40° C., the residue concentration present was determined.

### Preparation of Standards:

About 10 mg of fungicide were weighed into a 100 ml measuring flask and made up to the mark with methanol. The standards were placed for 3 min in an ultrasonic bath and subsequently diluted to a concentration of approximately 2 mg/l in methanol.

### Preparation and Determination of Samples:

Depending on fungicide content, 0.2-1 g of the dispersion sample was weighed into a 50 ml measuring flask and made up to the mark with methanol. The sample was shaken well and extracted for 15 min in the ultrasonic bath. Subsequently the sample was cooled to room temperature and filtered off through a Minisart filter (0.45 μm). For the determination of trans-resveratrol (F1), the sample was further diluted 1:1 with methanol.

The filtered sample was placed into a HPLC analytical vial provided therefor and introduced into the instrument (autosampler). Before measurement the column was flushed for 50 min using the mobile phase mixture consisting of 80 parts by weight of methanol, 120 parts by weight of water and 1 part by weight of acetic acid.

### Test Parameters:

Mobile phase (w/w): 80 methanol/20 water/1 acetic acid
Stationary phase: Partisil 5 C8, 5 μm 250 mm×4 mm
Sample volume: 5 μl

### Detector: UV 303 nm

Flow: 1.0 ml/min
Analysis time: 25 min

TABLE 2
Recovery rates of the fungicides after warm storage

| | | | | After 7 d at | Recovery |
|---|---|---|---|---|---|
| Example | Dispersion | pH | Addition | 40° C. | (%) |
| 6 | B | 3 | 285 ppm F1 | 285 ppm F1 | 100 |
| 7 | B | 4.5 | 285 ppm F1 | 285 ppm F1 | 100 |
| C2 | B | 3 | 351 ppm F2 | 129 ppm F2 | 37 |
| C3 | B | 4.5 | 361 ppm F2 | 335 ppm F2 | 93 |

The findings of examples 6 and 7 make it clear that the recovery rates of the fungicide trans-resveratrol of the invention are quantitative independent of pH and that the molecule is not attacked in a polymer dispersion under the storage conditions. This condition is not met by natamycin as polyene fungicide (comparative examples C2 and C3).

1. An aqueous polymer dispersion comprising
A) a polymer dispersion produced by free-radical polymerization of ethylenically unsaturated monomers,
B) stabilizers suitable for carrying out the free-radical polymerization, and also
C) 0.01 to 20 000 ppm by weight, based on the mass of the total dispersion, of at least one compound of the formula Ia and/or Ib 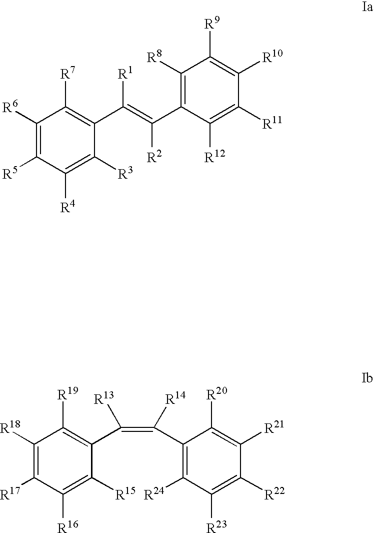
where R¹, R², R¹³ and R¹⁴ independently of one another are hydrogen, C₁-C₆-alkyl, C₁-C₆-alkoxy, carboxyl, nitrile, isonitrile, cyano or halogen,
R³, R⁴, R⁵, R⁶, R⁷, R⁸, R⁹, R¹⁰, R¹¹, R¹², R¹⁵, R¹⁶, R¹⁷, R¹⁸, R¹⁹, R²⁰, R²¹, R²², R²³, and R²⁴ independently of one another are hydrogen, C₁-C₁₂-alkyl, C₂-C₁₂-alkenyl, C₁-C₁₂-alkoxy, hydroxyl, carboxyl, —CO—R²⁵, —O—CO—R²⁶, the oxygen-bound monovalent radical of a carbohydrate or halogen, and
R²⁵ and R²⁶ independently of one another are C₁-C₁₂-alkyl or C₂-C₁₂-alkenyl,
with the proviso that at least one of the substituents R³, R⁴, R⁵, R⁶, R⁷, R⁸, R⁹, R¹⁰, R¹¹ or R¹², or R¹⁵, R¹⁶, R¹⁷, R¹⁸, R¹⁹, R²⁰, R²¹, R²², R²³ or
R²⁴ is hydroxyl and/or alkoxy and/or —O—CO—R²⁶.

2. An aqueous polymer dispersion as claimed in claim 1, wherein the polymer is derived from monomers of one or more of the following groups:
a) esters of acrylic acid and/or methacrylic acid with monohydric aliphatic saturated alcohols having one to eighteen carbon atoms including the monohydric aliphatic saturated alcohols which are derived from alkylene glycols;
b) esters of acrylic acid and/or methacrylic acid with dihydric aliphatic saturated alcohols having two to eighteen carbon atoms;
c) ester amides of acrylic acid and/or methacrylic acid with aliphatic saturated amino alcohols having two to eighteen carbon atoms;
d) vinyl esters or allyl esters of aliphatic saturated or unsaturated monocarboxylic acids having one to eighteen carbon atoms in the carboxylic acid moiety;
e) divinyl esters or diallyl esters of aliphatic saturated or unsaturated dicarboxylic acids having three to eighteen carbon atoms in the carboxylic acid moiety;
f) vinyl halides;
g) nitrites of ethylenically unsaturated monomers;
h) monounsaturated or polyunsaturated aliphatic or aliphatic-aromatic hydrocarbons which if appropriate have one or more halogen atoms;
i) esters of maleic and/or fumaric acid with monohydric saturated aliphatic alcohols having one to eighteen carbon atoms;
j) vinyl ethers of monohydric saturated aliphatic alcohols having one to eighteen carbon atoms;
k) ethylenically unsaturated carboxylic and/or sulfonic acids;
l) half esters of ethylenically unsaturated carboxylic and/or sulfonic acids having at least two acid groups with monohydric saturated aliphatic alcohols having one to eighteen carbon atoms;
m) vinyl heterocycles or allyl heterocycles; and/or
n) amides of ethylenically unsaturated carboxylic and/or sulfonic acids.

3. An aqueous polymer dispersion as claimed in claim 2, wherein the polymer is derived from vinyl esters of aliphatic saturated or unsaturated monocarboxylic acids having one to eighteen carbon atoms in the carboxylic acid moiety, in particular from vinyl acetate, vinyl propionate, vinyl butyrate, vinyl isobutyrate, vinyl pivalate, vinyl 2-ethylhexanoate, vinyl esters of α-branched carboxylic acids having 9 to 11 carbon atoms in the acid radical, and also from vinyl esters of lauric, palmitic, myristic and stearic acids.

4. An aqueous polymer dispersion as claimed in claim 3, wherein the polymer is derived from combinations of one or more of the vinyl esters with ethylene.

5. An aqueous polymer dispersion as claimed in claim 2, wherein the polymer is derived from esters of acrylic acid and/or esters of methacrylic acid with monohydric aliphatic saturated alcohols having one to eight carbon atoms which are used if optionally together with alpha-olefins and/or vinyl esters.

6. An aqueous polymer dispersion as claimed in claim 2, wherein the polymer is derived from esters of maleic and/or fumaric acid with monohydric saturated aliphatic alcohols having four to eight carbon atoms, which are used optionally in combination with alpha-olefins and/or vinyl esters.

7. An aqueous polymer dispersion as claimed in claim 1, wherein the polymer is derived from one or more of the following monomers:
vinyl acetate,
ethylene,
vinyl esters of saturated fatty acids of chain length C₂-C₁₈,
maleic and/or fumaric esters with monohydric saturated aliphatic alcohols of chain length C₄-C₈, and/or
acrylic and/or methacrylic esters with monohydric saturated aliphatic alcohols of chain length C₁-C₈ in combination with alpha-olefins of chain length C₂-C₁₈.

8. An aqueous polymer dispersion as claimed in claim 2, wherein the polymer is derived from one or more of the following monomers:
vinyl esters of saturated fatty acids of chain length C₂-C₁₈, and/or
maleic and/or fumaric esters with monohydric saturated aliphatic alcohols of chain length C₄-C₈ and/or
ethylene.

9. An aqueous polymer dispersion as claimed in claim 1, wherein the polymer comprises a compound of the formula Ia or a combination of compounds of the formulae Ia and Ib.

10. An aqueous polymer dispersion as claimed in claim 1, wherein at least two of the substituents R³, R⁴, R⁵, R⁶, R⁷, R⁸, R⁹, R¹⁰, R¹¹ or R , or R¹⁵, R¹⁶, R¹⁷, R¹⁸, R¹⁹, R²⁰, R²¹, R²², R²³ or R²⁴, are hydroxyl and/or alkoxy.

11. An aqueous polymer dispersion as claimed in claim 1, wherein R¹ and R², or R¹³ and R¹⁴, are hydrogen.

12. An aqueous polymer dispersion as claimed in claim 1, wherein at least two R³, R⁴, R⁵, R⁶, R⁷, R⁸, R⁹, R¹⁰, R¹¹ or R¹², or R¹⁵, R¹⁶, R¹⁷, R¹⁸, R¹⁹, R²⁰, R²¹, R²², R²³ or R²⁴ are hydroxyl and/or alkoxy, and where at least one of the substituents R³, R⁴, R⁵, R⁶, R⁷, R⁸, R⁹, R¹⁰, R¹¹ or R¹², or R¹⁵, R¹⁶, R¹⁷, R¹⁸, R¹⁹, R²⁰, R²¹, R²², R²³ or R²⁴ are alkyl and/or alkenyl and/or acyloyl and/or an oxygen-bound radical of a carbohydrate.

13. An aqueous polymer dispersion as claimed in claim 12, wherein at least two of the substituents R³, R⁴, R⁵, R⁶, R⁷, R⁸, R⁹, R¹⁰, R¹¹ or R¹², or R¹⁵, R¹⁶, R¹⁷, R¹⁸, R¹⁹, R²⁰, R²¹, R²², R²³ or R²⁴ are hydroxyl, and where at least one of the substituents R³, R⁴, R⁵, R⁶, R⁷, R⁸, R⁹, R¹⁰, R¹¹ or R¹², or R¹⁵, R¹⁶, R¹⁷, R¹⁸, R¹⁹, R²⁰, R²¹, R²², R²³ or R²⁴ are alkoxy, and/or acyloyl and/or an oxygen-bound radical of a carbohydrate.

14. An aqueous polymer dispersion as claimed in claim 1, wherein the compounds of the formulae Ia and/or Ib which are selected from the group consisting of 4-hydroxystilbene, 3,5-dihydroxystilbene (pinosylvin), 4,4′-dihydroxystilbene, 3,5,4′-trihydroxystilbene (resveratrol), 3,5,3′,4′-tetrahydroxystilbene, 3,5,2′,4′-tetrahydroxystilbene (oxyresveratrol), 3,5,2′,4′-tetrahydroxy-4-(2,6-dimethylocta-2,5-dienyl)stilbene (chlorophorin), 3-hydroxy-5-methoxystilbene (pinosylvin monomethyl ether), 3′-methoxy-4′-hydroxystilbene, 3,5,3′-trihydroxy-4′-methoxystilbene (rhapontigenin), 4′-hydroxy-4,3′-dimethoxystilbene, 4′-hydroxy-3,5-dimethoxystilbene (pterostilbene), 3,3′-dimethoxy-4,4′-dihydroxystilbene, 5,4′-dihydroxy-3-(O-D-glucosidyl)stilbene (resveratrol glucoside), 5,4′,5′-trihydroxy-3-(O-D-glucosidyl)stilbene (astringin), 5,3′-dihydroxy-4′-methoxy-3-(O-D-glucosidyl)stilbene (rapotin), 3,5-dihydroxy-4′-methoxystilbene, 3,4′-dihydroxy-5-hydroxystilbene, 3,4′-dihydroxy-5-(O-D-glucosidyl)stilbene piccid), 3,5,3′-trihydroxy-4′-methoxystilbene (rhapontigenin), 3,5-dihydroxy-4′-methoxy-3′-(O-D-glucosidyl)stilbene (rhaponticin), 3,5,4′-trimethoxystilbene (trimethylresveratrol), 3,5-dimethoxy-4′-acetylstilbene (pterostilbene acetate), 3,4,2′,4′,6′-pentamethoxystilbene, 5-methoxy-3-(O-D-glucosidyl)stilbene (pinosylvin monomethyl ether glucoside), 3′-methoxy-4′-hydroxystilbene glucoside, 3′-methoxy-4′-(O-hydroxyglucoside acetate)stilbene, 4′-methoxy-5,3′-diacetyl-3-(O-D-glucosidyl acetate)stilbene (rhapotin acetate), 4,3′-dimethoxy-4′-hydroxystilbene glucoside, 4,3′-dimethoxy-4′-hydroxystilbene glucoside acetate, 3,5,2′,4′-tetraacetylstilbene (oxyresveratrol acetate) and 5,3′,4′-triacetyl-3-(O-D-glucosidyl)stilbene (astringin acetate).

15. An aqueous polymer dispersion as claimed in claim 14, wherein the formula Ia is made of E-3,5,4′-trihydroxystilbene.

16. An aqueous polymer dispersion as claimed in claim 1, which further comprises a biocidally active compound in addition to the compounds of formula Ia and/or Ib.

17. An aqueous polymer dispersion as claimed in claim 16, wherein said biocidall active compound is polyene fungicide.

18. An aqueous polymer dispersion as claimed in claim 16, wherein said biocidally active compound contains sorbic acid, esters thereof and/or salts thereof.

19. An aqueous polymer dispersion as claimed in claim 18, wherein the polymer contains at least one compound of the formula Ia and at least one alkali metal salt or alkaline earth metal salt of sorbic acid.

20. An aqueous polymer dispersion as claimed in claim 1, wherein the polymer contains copolymer polyvinyl ester dispersions and at least one compound of the formula Ia.

21. An aqueous polymer dispersion as claimed in claim 1, wherein the polymer contains aqueous polyacrylate and/or polymethacrylate dispersions and at least one compound of the formula Ia.

22. An aqueous polymer dispersion as claimed in claim 1, wherein the polymer contains at least one protective colloid as stabilizer B) suitable for carrying out the free-radical polymerization.

23. An aqueous polymer dispersion as claimed in claim 22, wherein said protective colloid is at least one polyvinyl alcohol.

24. An aqueous polymer dispersion as claimed in claim 1, wherein the polymer contains at least one emulsifier as stabilizer B) suitable for carrying out the free-radical polymerization.

25. An aqueous polymer dispersion as claimed in claim 24, wherein said emulsifier contains at least one nonionic emulsifier.

26. A redispersible polymer powder obtainable by atomizing an aqueous polymer dispersion as claimed in claim 1.

27. A film obtainable by film-forming the aqueous plastic dispersions as claimed in claim 1.

28. A film as claimed in claim 27, wherein the polymer is a coating.

29. (canceled)

30. (canceled)

31. An aqueous polymer dispersion as claimed in claim 2, wherein the polymer is derived from dibutyl maleinate and/or dibutyl fumarate which are used optionally in combination with ethylene and/or vinyl acetate.

32. A coating agent and/or as packaging material for foods, as colors or as adhesives which comprises the aqueous polymer dispersion as claimed in claim 1.

33. An aid for cheese ripening which comprises the aqueous polymer dispersion as claimed in claim 1.
